(19) United States
(12) Patent Application Publication
(10) Pub. No.: US 2024/0014651 A1
(43) Pub. Date: Jan. 11, 2024

(54) PROBABILITY ESTIMATION METHOD FOR PHOTOVOLTAIC POWER BASED ON OPTIMIZED COPULA FUNCTION AND PHOTOVOLTAIC POWER SYSTEM

(71) Applicants: UNIVERSITY OF JINAN, Jinan (CN); SHANDONG UNIVERSITY, Jinan (CN)

(72) Inventors: Jie Shi, Jinan (CN); Zuan Fu, Jinan (CN); Mingqiang Wang, Jinan (CN); Jie Gao, Jinan (CN)

(73) Assignees: UNIVERSITY OF JINAN, Jinan (CN); SHANDONG UNIVERSITY, Jinan (CN)

(21) Appl. No.: 18/337,427

(22) Filed: Jun. 19, 2023

(30) Foreign Application Priority Data
Jul. 7, 2022 (CN) 2022107947399

(51) Int. Cl. H02J 3/00; H02J 3/38

(52) U.S. Cl. CPC H02J 3/004; H02J 3/381; H02J 2203/20; H02J 2300/24

(57) ABSTRACT

The present disclosure discloses a probability estimation method for photovoltaic power based on an optimized copula function and a photovoltaic power system. According to the method, weather types are classified by a clustering method to obtain a plurality of weather types, clustering is carried out based on historical meteorological data, and a copula function model is constructed based on clustering results. Historical operation data and weather classification results are considered at the same time to make the obtained hybrid Copula function model have higher prediction accuracy.

### BACKGROUND

### Technical Field

The present disclosure relates to a probability estimation method for photovoltaic power based on an optimized copula function and also relates to a photovoltaic power system using the probability estimation method for photovoltaic power, and belongs to the technical field of photovoltaic power generation.

### Related Art

With the advantages of abundant exploitable resources, low development and construction difficulties, and significant energy-saving and environment-protecting benefits, distributed photovoltaic power stations are one of the important ways for photovoltaic development and utilization. However, because of the instability of weather conditions, photovoltaic power generation is highly intermittent and random, which poses a challenge to the planning and operation of existing power systems. Therefore, accurate prediction for the power generated by photovoltaic power generation is one of the important influencing factors for photovoltaic access to the power system.

Copula function is a statistics tool used for dealing with the correlation between random variables. Modeling with the copula function can better represent the spatial correlation of a power generation system of the distributed photovoltaic power stations, and the amount of data required is relatively small. However, due to great limitations, the traditional copula function cannot fit the power data well, resulting in low accuracy for predicting the photovoltaic power.

### SUMMARY

To address the shortcomings of the prior art, the primary technical problem to be solved by the present disclosure is to provide a probability estimation method for photovoltaic power based on an optimized copula function.

A further technical problem to be solved by the present disclosure is to provide a photovoltaic power system using the above probability estimation method for photovoltaic power.

To achieve the above objective of the present disclosure, the present disclosure uses the following technical solution.

According to the first aspect of an embodiment of the present disclosure, a probability estimation method for photovoltaic power based on an optimized copula function is provided, including the following steps:
(1) classifying, according to historical photovoltaic power data obtained from a centralized photovoltaic power station and a distributed photovoltaic power station, weather types by a clustering method to obtain a plurality of weather types;
(2) constructing, according to the cumulative distribution of the photovoltaic output obtained from photovoltaic data under different weather types, a plurality of copula function models for quantitatively representing the spatial correlation of the power of the centralized photovoltaic power station and the distributed photovoltaic power station, respectively;
(3) evaluating the plurality of copula function models respectively for different weather, and obtaining a copula function model achieving the highest accuracy for predicting the photovoltaic power under the corresponding different weather as an optimal model;
(4) achieving, according to the obtained data of the centralized photovoltaic power station, point prediction of the distributed photovoltaic power station, through the optimal model of the corresponding weather;
(5) constructing, based on the relationship between an actual value and a value of point prediction of the distributed photovoltaic power station, a conditional probability model and obtaining, through the conditional probability model, the probability distribution of the power of the distributed photovoltaic power station and the conditional probability corresponding to the value of point prediction; and
(6) obtaining, based on a real value of the power of the centralized photovoltaic power station at the future moment and in combination with the above conditional probability model, a predicted value of the power generated by the distributed photovoltaic power station at the future moment.

Preferably, step (1) includes the following sub-steps:
obtaining historical photovoltaic power data and performing data cleaning; and
obtaining meteorological data in the corresponding period of the historical photovoltaic power data, and determining, based on correlation analysis, clustering elements to cluster the weather to obtain the plurality of weather types.

Preferably, the correlation analysis is used for determining meteorological factors affecting the photovoltaic output as the clustering elements; and
according to the determined clustering elements, the weather is clustered using a k-means algorithm.

Preferably, the meteorological factors include an atmospheric pressure, relative humidity and radiancy.

Preferably, in step (2), the plurality of copula function models include a Frank Copula function model and a hybrid Copula function model, the hybrid Copula function model being a weighted sum of the Frank Copula function model and other models in an Archimedean Copula function cluster model.

Preferably, the hybrid Copula function model is obtained by the following sub-steps:
obtaining, according to the cumulative distribution of the photovoltaic output, a correlation coefficient λ value under each weather type, and establishing the Frank Copula function model; and
constructing, based on other functions in an Archimedean Copula function cluster other than a Frank Copula function, a Copula function cluster model corresponding to each weather, and weighting and summing the Copula function cluster model and the Frank Copula function model according to weights to obtain an optimized hybrid Copula function model.

Preferably, in step (3), an optimal Copula model corresponding to each weather type is selected from a Frank Copula model and an optimized hybrid Copula function model by comparing correlation coefficients and an error evaluation index under different weather.

Preferably, the correlation coefficients include: a Pearson correlation coefficient and a determination coefficient R₂, and the error evaluation index is a root mean square error.

According to the second aspect of an embodiment of the present disclosure, a probability estimation apparatus for photovoltaic power based on an optimized copula function is provided, including a processor and a memory, the processor reading a computer program in the memory for executing the above probability estimation method for photovoltaic power based on an optimized copula function.

According to the third aspect of an embodiment of the present disclosure, a photovoltaic power system is provided, including a plurality of power generation units; a centralized photovoltaic power station or a distributed photovoltaic power station in each power generation unit being each connected to a power grid through a corresponding photovoltaic inverter and transformer. The photovoltaic power system uses the above probability estimation method for photovoltaic power based on an optimized copula function to estimate the photovoltaic power.

Compared with the prior art, the probability estimation method for photovoltaic power provided by the present disclosure creatively applies the combination of a clustering algorithm and the optimized copula model under weather classification to the field of predicting the power of the distributed photovoltaic power station, carries out weather clustering based on historical meteorological data, and constructs the copula function model based on the clustering results. Historical operation data and weather classification results are considered at the same time to make the obtained hybrid Copula function model have higher prediction accuracy. The probability estimation method for photovoltaic power predicts the power of the distributed photovoltaic power station through the centralized photovoltaic power station, solving the problem that operational data of the distributed photovoltaic power station is difficult to collect and providing strong support for the safe and stable operation of the photovoltaic power system.

### BRIEF DESCRIPTION OF THE DRAWINGS

FIG. 1 is an overall flowchart of a probability estimation method for photovoltaic power provided by an embodiment of the present disclosure;

FIG. 2 is a diagram showing a weather clustering result using a k-means algorithm in an embodiment of the present disclosure;

FIG. 3(a) is a frequency histogram of the output of centralized and distributed photovoltaic power stations under a cloudy day type in an embodiment of the present disclosure;

FIG. 3(b) is a frequency histogram of the output of centralized and distributed photovoltaic power stations under a sunny day type in an embodiment of the present disclosure;

FIG. 3(c) is a frequency histogram of the output of centralized and distributed photovoltaic power stations under an overcast day type in an embodiment of the present disclosure;

FIG. 4(a) is a density map of an optimized copula function under a cloudy day type in an embodiment of the present disclosure;

FIG. 4(b) is a density map of an optimized copula function under a sunny day type in an embodiment of the present disclosure;

FIG. 4(c) is a density map of an optimized copula function under an overcast day type in an embodiment of the present disclosure;

FIG. 5(a) shows a real value and a predicted value of the photovoltaic output under a cloudy day type in an embodiment of the present disclosure;

FIG. 5(b) shows a real value and a predicted value of the photovoltaic output under a sunny day type in an embodiment of the present disclosure;

FIG. 5(c) shows a real value and a predicted value of the photovoltaic output under an overcast day type in an embodiment of the present disclosure;

FIG. 6(a) is a conditional probability distribution diagram of the photovoltaic output under a cloudy day type in an embodiment of the present disclosure;

FIG. 6(b) is a conditional probability distribution diagram of the photovoltaic output under a sunny day type in an embodiment of the present disclosure;

FIG. 6(c) is a conditional probability distribution diagram of the photovoltaic output under an overcast day type in an embodiment of the present disclosure;

FIG. 7(a) shows a real value, a predicted value and a corresponding confidence interval of the photovoltaic output under a cloudy day type in an embodiment of the present disclosure;

FIG. 7(b) shows a real value, a predicted value and a corresponding confidence interval of the photovoltaic output under a sunny day type in an embodiment of the present disclosure;

FIG. 7(c) shows a real value, a predicted value and a corresponding confidence interval of the photovoltaic output under an overcast day type in an embodiment of the present disclosure;

FIG. 8 is a schematic diagram of a probability estimation apparatus for photovoltaic power provided by an embodiment of the present disclosure;

FIG. 9 is a schematic diagram of a photovoltaic power system using the above probability estimation method for photovoltaic power in an embodiment of the present disclosure; and

FIG. 10 is a schematic structural diagram of each power generation unit in the photovoltaic power system as shown in FIG. 9.

### DETAILED DESCRIPTION

The technical content of the present disclosure is described in detail below with reference to the accompanying drawings and specific embodiments.

An embodiment of the present disclosure provides a probability estimation method for photovoltaic power based on an optimized copula function. In the method, according to historical photovoltaic power data obtained from a centralized photovoltaic power station and a distributed photovoltaic power station, weather types are classified by a clustering method to obtain a plurality of weather types. Then, according to the cumulative distribution of the photovoltaic output obtained from photovoltaic data under different weather types, a plurality of copula function models for quantitatively representing the spatial correlation of the power of the centralized photovoltaic power station and the distributed photovoltaic power station are constructed, respectively, and for the characteristics of each weather attribute, the optimal representative weight of a Copula function is constructed, so as to select a corresponding optimal model for different weather, which is used for quantitatively expressing the spatial correlation of the power of the centralized photovoltaic power station and the distributed photovoltaic power station. According to the obtained data of the centralized photovoltaic power station, point prediction of the distributed photovoltaic power station is achieved through the optimal model of the corresponding weather. Based on the relationship between an actual value and a value of point prediction of the distributed photovoltaic power station, a conditional probability model is constructed, and through the conditional probability model, the probability distribution of the power of the distributed photovoltaic power station and the conditional probability corresponding to the value of point prediction are obtained. Finally, based on a real value of the power of the centralized photovoltaic power station at the future moment and in combination with the above conditional probability model, a predicted value of the power generated by the distributed photovoltaic power station at the future moment is obtained.

The specific steps of the above estimation method are described in detail below in combination with various embodiments.

### EMBODIMENT I

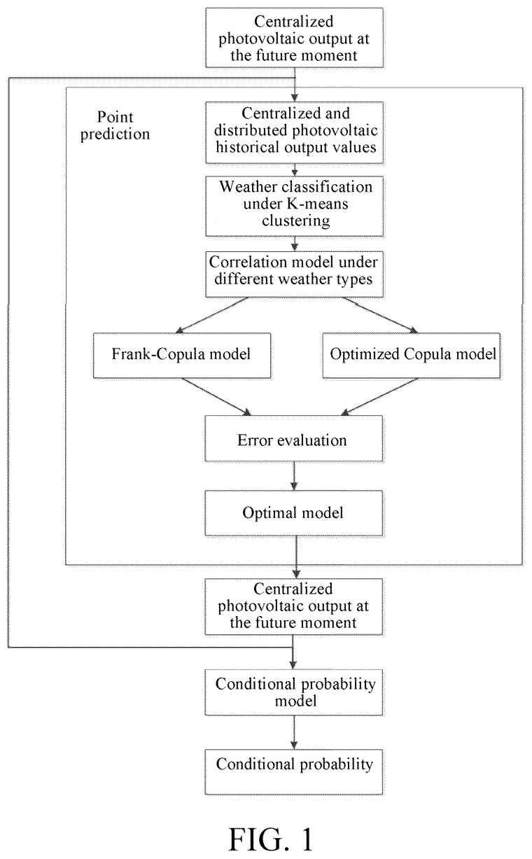

As shown in FIG. 1 to FIG. 7, Embodiment I of the present disclosure provides a probability estimation method for photovoltaic power based on an optimized copula function, at least including the following steps:
step 1: classifying, according to historical photovoltaic power data obtained from a centralized photovoltaic power station and a distributed photovoltaic power station, weather types by a clustering method to obtain a plurality of weather types;
step 2: constructing, according to the cumulative distribution of the photovoltaic output obtained from photovoltaic data under different weather types, a plurality of copula function models for quantitatively representing the spatial correlation of the power of the centralized photovoltaic power station and the distributed photovoltaic power station, respectively;
step 3: evaluating the plurality of copula function models respectively for different weather, and obtaining a copula function model achieving the highest accuracy for predicting the photovoltaic power under the corresponding different weather as an optimal model;
step 4: achieving, according to the obtained data of the centralized photovoltaic power station, point prediction of the distributed photovoltaic power station, through the optimal model of the corresponding weather;
step 5: constructing, based on the relationship between an actual value and a value of point prediction of the distributed photovoltaic power station, a conditional probability model and obtaining, through the conditional probability model, the probability distribution of the power of the distributed photovoltaic power station and the conditional probability corresponding to the value of point prediction; and
step 6: obtaining, based on a real value of the power of the centralized photovoltaic power station at the future moment and in combination with the above conditional probability model, a predicted value of the power generated by the distributed photovoltaic power station at the future moment.

It is to be noted that: the Copula function in the embodiment of the present disclosure (detailed description of the Copula function can refer to the following link: http://www.columbia.edu/˜mh2078/QRM/Copulas.pdf) describes correlations between different variables and is actually a class of functions that connect joint distribution functions to respective marginal distribution functions thereof, also known as a connectivity function. In step 2, the plurality of copula function models include a Frank Copula function model and a hybrid Copula function model. The hybrid Copula function model is a weighted sum of the Frank Copula function model and other models in an Archimedean Copula function cluster model.

In step 1, performing weather clustering based on historical meteorological data in preparation for modeling of the copula function model, specifically includes the following sub-steps.

Step 1.1: historical photovoltaic power data is obtained and data cleaning is performed.

Specifically, the historical photovoltaic power data includes historical power data of the centralized photovoltaic power station and the distributed photovoltaic power station. On this basis, data cleaning is performed on a photovoltaic historical output value to exclude an abnormal value and zero and negative values.

Optionally, the photovoltaic data collected in the embodiment of the present disclosure is the power data of the photovoltaic power station on January, February and December, with a sampling interval of 10 min.

Step 1.2: Meteorological data in the corresponding period of the historical photovoltaic power data is obtained, and based on correlation analysis, clustering elements are determined to cluster the weather to obtain the plurality of weather types.

Specifically, a k-means algorithm is used in the embodiment of the present disclosure, including the following sub-steps.

Step 1.2-1: the correlation analysis is used for determining meteorological factors affecting the photovoltaic output as the clustering elements.

The meteorological data of the date corresponding to the photovoltaic historical output value is selected and, after correlation analysis, is as shown in Table 1 below, the finally determined meteorological factors include three characteristics of an atmospheric pressure, relative humidity and radiancy, as the clustering elements. By the correlation analysis, the correlation with the power generated by photovoltaic power generation can be comprehensively measured by counting correlation coefficients including Pearson, Spearman, and Kendall.

TABLE 1

| | Correlation coefficient | | | | |
|---|---|---|---|---|---|
| Correlation | | | | Atmo- | Short |
| coefficient | Temper- | Air | Relative | spheric | wave |
| type | ature | speed | humidity | pressure | radiancy |
| Pearson | −0.086241 | −0.079835 | −0.117157 | 0.291342 | −0.482026 |
| Spearman | −0.027598 | −0.046897 | −0.081194 | 0.291036 | −0.408235 |
| Kendall | −0.034007 | −0.034398 | −0.054801 | 0.201674 | −0.350357 |

Pearson represents a Pearson correlation coefficient, Spearman represents a Spearman rank correlation coefficient, and Kendall represents a Kendall rank correlation coefficient.

In an embodiment of the present disclosure, from the five meteorological factors, three factors with high correlations are selected as classification data, i.e., an atmospheric pressure, relative humidity, and radiancy.

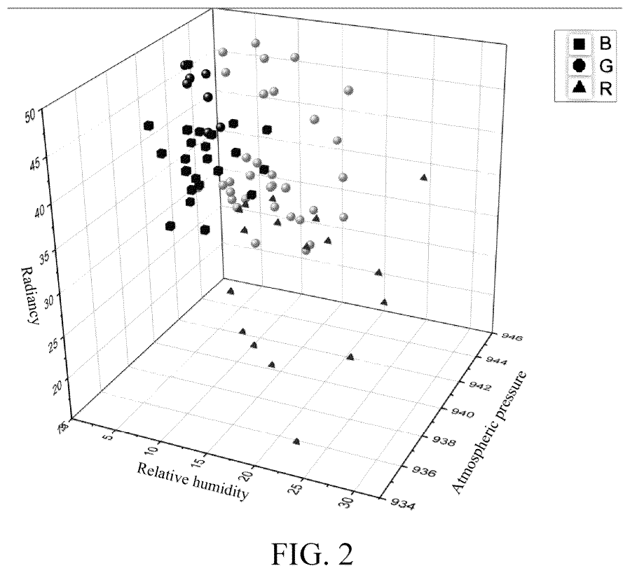

Step 1.2-2: according to the determined clustering elements, the weather is clustered using a k-means algorithm. The results are as shown in FIG. 2. According to the range of all the meteorological factors corresponding to the clustering results, three weather types, a cloudy day, a sunny day, and an overcast day, are finally determined.

Here, using the k-means algorithm can better reflect the temporal and spatial correlation of the output of the distributed photovoltaic power station and improve the prediction accuracy to a certain extent.

In step 2, for the obtained weather types, the cumulative distribution of the photovoltaic output under each weather type is calculated in order to establish the Frank Copula function model and the hybrid Copula function model, respectively.

Step 2-1: according to the cumulative distribution of the photovoltaic output, a correlation coefficient λ value under each weather type is obtained, and the Frank Copula function model is established.

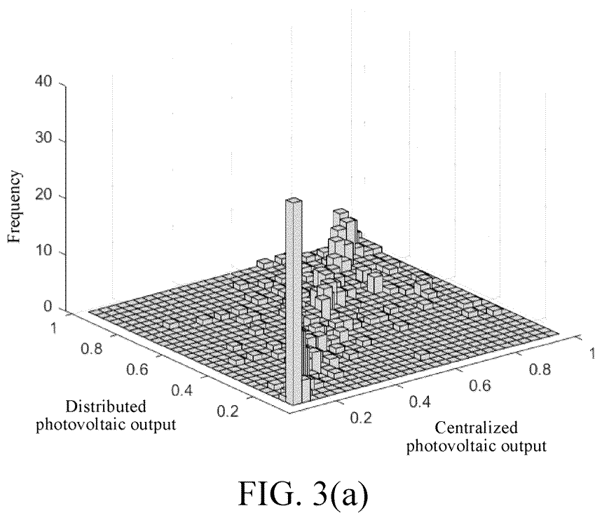

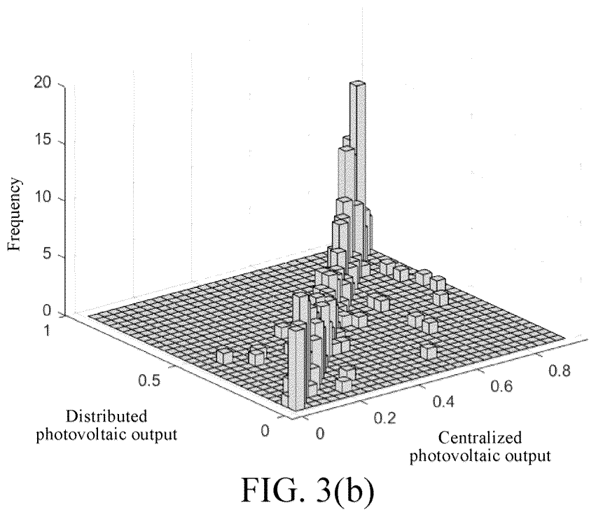

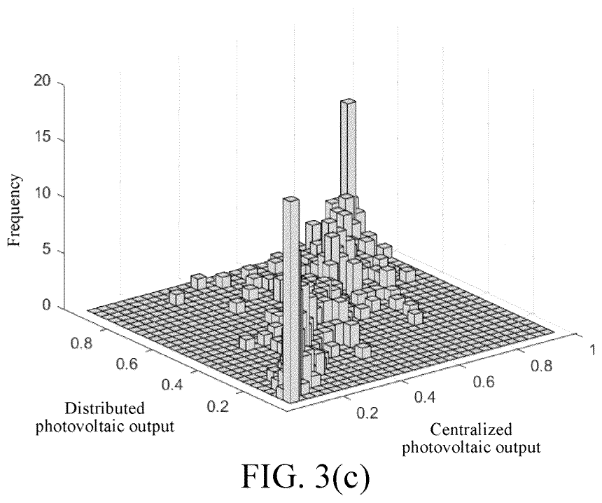

The frequency distributions are observed, as shown in FIG. 3(a) to FIG. 3(c). Under different weather, the frequency distributions will differ, but in general satisfy the symmetric tail correlation, the Frank Copula function can be used for carrying out modeling, respectively, and the established Frank Copula function model is shown as follows:

$${C}_{F} ( u , v ; λ ) = - \frac{1}{λ} ln [ 1 + \frac{( {e}^{- λ u} - 1 ) ( {e}^{- λ v} - 1 )}{{e}^{- λ} - 1} ] \qquad ( 1 )$$

In Equation (1), u and v are two marginal distribution variables; and λ is the correlation coefficient, according to the cumulative distribution of the photovoltaic output, a λ value under each weather type can be obtained, and the Frank Copula function model under each weather type can be obtained.

Step 2-2: based on other functions in an Archimedean Copula function cluster other than a Frank Copula function, the Copula function cluster model corresponding to each weather is constructed, and the Copula function cluster model and the Frank Copula function model are weighted and summed according to weights to obtain an optimized hybrid Copula function model.

In an embodiment of the present disclosure, on the basis of the Archimedean Copula function cluster, parameters are solved and optimized by an optimization algorithm, which can further improve the accuracy of prediction. The specific description is as follows: in addition to the Frank Copula function, two other functions in the Archimedean Copula are still used in the embodiment of the present disclosure, including: a Gumble Copula function and a Clayton Copula function, as shown in Equation (2) and Equation (3), respectively.

$${C}_{G} ( u , v ; λ ) = exp \{ - {[ {( - ln u )}^{\frac{1}{λ}} + {( - ln v )}^{\frac{1}{λ}} ]}^{λ} \} \qquad ( 2 )$$

$${C}_{C} ( u , v ; λ ) = {( {u}^{- λ} + {v}^{- λ} - 1 )}^{- \frac{1}{λ}} \qquad ( 3 )$$

The optimized hybrid Copula function model is obtained after weighting, as shown in Equation (4):

C_{H}(u, v;λ₁, λ₂, λ₃)=A*C_{F}(u, v; λ₁)+B*C_{c}(u, v; λ₂)+C*C_{G}(u, v; λ₃) (4)

In Equation (4), A, B and C are the weight coefficients of Frank Copula, Clayton Copula and Gumble Copula, respectively; and λ₁, λ₂, λ₃ are the corresponding correlation coefficients.

The weight coefficient and the correlation coefficients λ₁, λ₂, λ₃ are solved in such a way that the weight coefficient and the correlation coefficients are brought into Equation (4) based on Equations (1) to (3) to obtain a copula value to be solved, and the copula value set according to experience is used as the set value, so that the error between the copula value obtained and the copula value set according to experience is solved as an objective function, and a genetic algorithm is used for solving parameters, then all the parameter values to be solved can be obtained, and the weight coefficient and the correlation coefficients λ₁, λ₂, λ₃ are obtained.

In the above embodiment, the optimized hybrid Copula function model is obtained based on the Archimedean Copula function cluster, which improves the prediction accuracy to a certain extent and can better fit the power data. The parameter values and weight values in the function cluster are determined according to the optimization algorithm, which overcomes the limitations of the traditional single copula function and is particularly suitable for fitting photovoltaic power data.

In step 3, the optimal Copula model corresponding to each weather type is selected from the Frank Copula model and the optimized hybrid Copula function model by comparing the correlation coefficients and an error evaluation index under different weather.

Specifically, the correlation coefficients and the error index are as shown in Table 2 below, and the optimal Copula model under each weather type is selected. The selected coefficients include: a Pearson correlation coefficient and a determination coefficient R², and the error evaluation index is a root mean square error (RMSE). Due to the error relationship and similarity between the real value and the model predicted value, a model with the best index under each weather type is selected as the optimal Copula model according to the above evaluation index.

TABLE 2

| | Evaluation index | | | | | |
|---|---|---|---|---|---|---|
| | RMSE | | R² | | Pearson | |
| | | Hybrid | | Hybrid | | Hybrid |
| Weather | Single | Copula | Single | Copula | Single | Copula |
| type | model | model | model | model | model | model |
| Cloudy day | 54.87 | 53.02 | 0.47 | 0.54 | 0.79 | 0.83 |
| Sunny day | 37.02 | 37.19 | 0.74 | 0.75 | 0.88 | 0.88 |
| Overcast day | 55.97 | 55.54 | 0.39 | 0.41 | 0.75 | 0.76 |

It is to be noted that: in Table 2, the single model refers to the Frank Copula model, and the hybrid Copula model refers to the hybrid Copula function model in Equation (4).

The Pearson correlation coefficient (PCC) indicates the trend and the degree of change between two variables, taking values between −1 and +1, with 0 representing no correlation, a positive value representing positive correlation, and a negative value representing negative correlation; and the larger the value is, the higher the correlation is.

The determination coefficient R^{2 ,} also known as the goodness of fit, is the square of the correlation coefficient r, and indicates that the variation in the dependent variable can be explained based on the variation in the independent variable. The magnitude of the determination coefficient R² determines the closeness of the correlation. The greater the goodness of fit is, the higher the degree of explanation of the dependent variable by the independent variable is and the higher the percentage of the variation caused by the independent variable in the total variation is. Observation points are more dense near a regression line.

For both a cloudy day and an overcast day, the error index of the hybrid Copula model is superior to that of the Frank Copula model, and the optimized hybrid Copula model is applied preferentially under this weather condition. For a sunny day, the determination coefficient R² of the optimized Copula model is improved, but RMSE is weaker than that of the Frank Copula model. The two models are equal in Pearson, and the effects of the two models are similar under this condition, and the hybrid Copula model can also be selected for a sunny day.

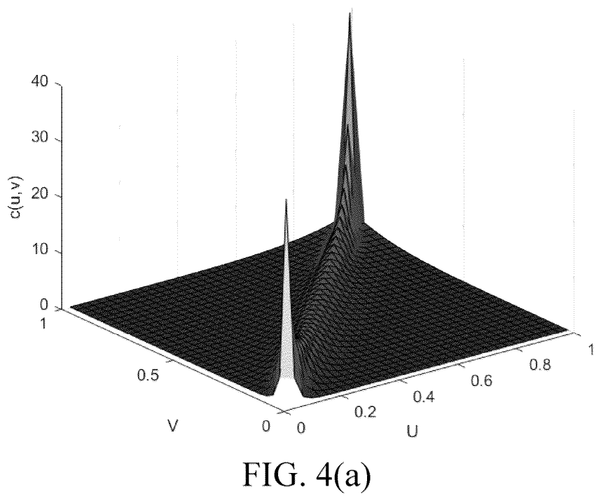

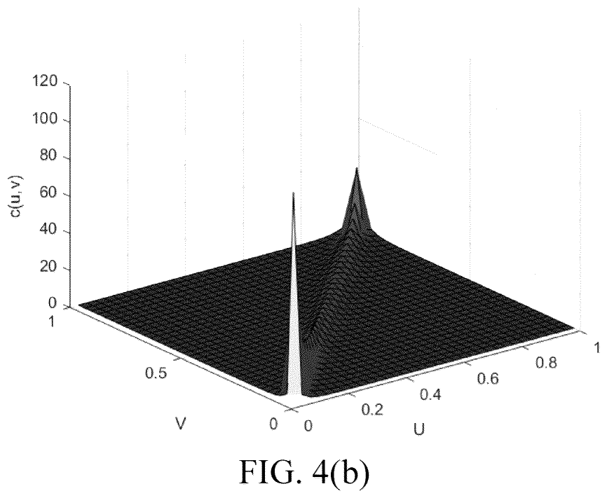

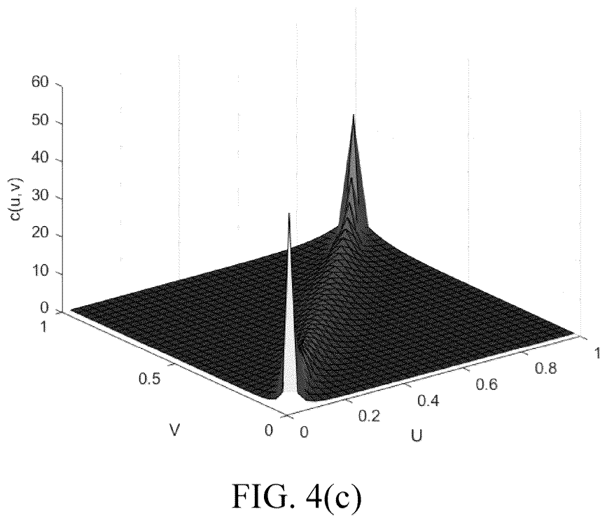

In an embodiment of the present disclosure, clustering is performed with three weather types: a cloudy day, an overcast day and a sunny day, and the same way can be used for other weather types to select the optimal model. The density maps of a cloudy day, an overcast day and a sunny day are as shown in FIG. 4(a) to FIG. 4(c).

In step 4, the copula functions under different weather are used, the power prediction results of the centralized photovoltaic power station are used as input to obtain the point prediction results of the power of the distributed photovoltaic power station by the corresponding model.

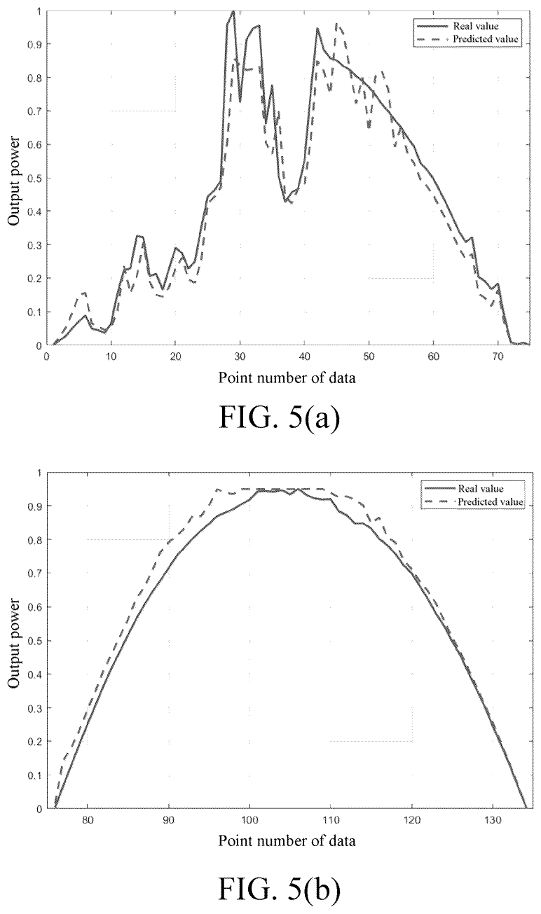

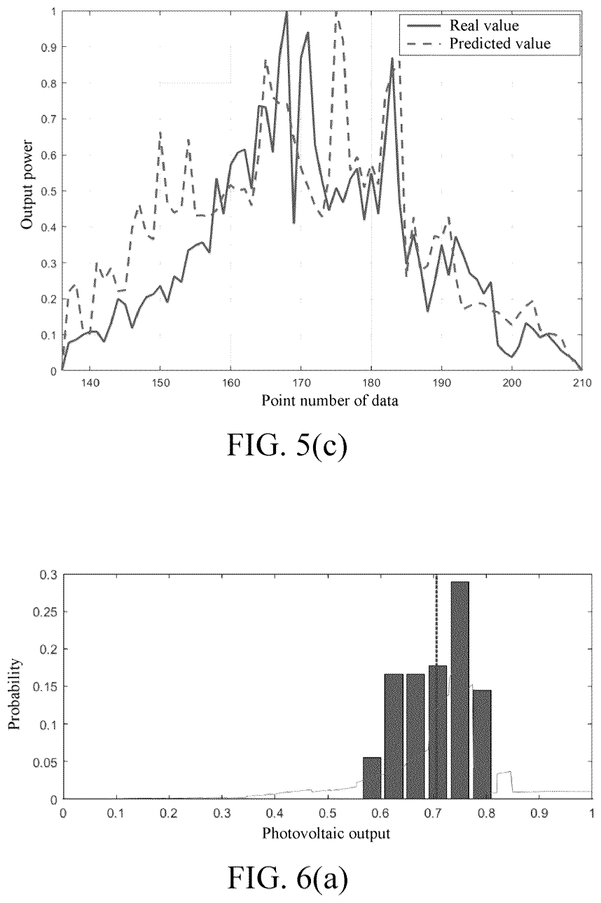

Specifically, some point prediction results under each weather are selected, and the effect views of point prediction under multiple weather types are obtained by the hybrid Copula model established in the embodiment of the present disclosure, as shown in FIG. 5(a) to FIG. 5(c). It can be seen from FIG. 5(a) to FIG. 5(c) that when the probability estimation method for photovoltaic power provided by the embodiment of the present disclosure is used for predicting the photovoltaic power, a predetermined effect can be obtained.

In step 5, based on the relationship between the actual value and the value of point prediction of the distributed photovoltaic power station, a conditional probability model is constructed, and through the conditional probability model, the probability distribution of the power generated by the distributed photovoltaic power station and the conditional probability corresponding to the value of point prediction are obtained.

In an embodiment of the present disclosure, the actual value is assumed as x and the value of point prediction is assumed as Y , then the joint probability function density of x and y is as shown in Equation (5).

$${f}_{XY} ( x , y ) = \frac{{F}_{XY} ( x , y )}{\partial x \partial y} = c ( {F}_{X} ( x ) , {F}_{Y} ( y ) ) {f}_{X} ( x ) {f}_{Y} ( y ) \qquad ( 5 )$$

In Equation (5), fₓ(x) and f_{Y}(y) are the probability function densities of the marginal distributions of x and y respectively; and C(Fₓ(x), F_{Y}(y)) is the density of the Copula function.

The density of the Copula function is obtained according to the hybrid Copula function model established by Equation (4). The probability density of the marginal distribution is obtained from the data of the output of the centralized photovoltaic power station and the distributed photovoltaic power station, respectively.

Given the point prediction y=P , the density of the conditional probability function of the actual value is as shown in Equation (6).

$${f}_{X \vert Y} ( x \vert y = p ) = \frac{{f}_{XY} ( x , p )}{{f}_{Y} ( p )} = c ( {F}_{X} ( x ) , {F}_{Y} ( p ) ) {f}_{X} ( x ) \qquad ( 6 )$$

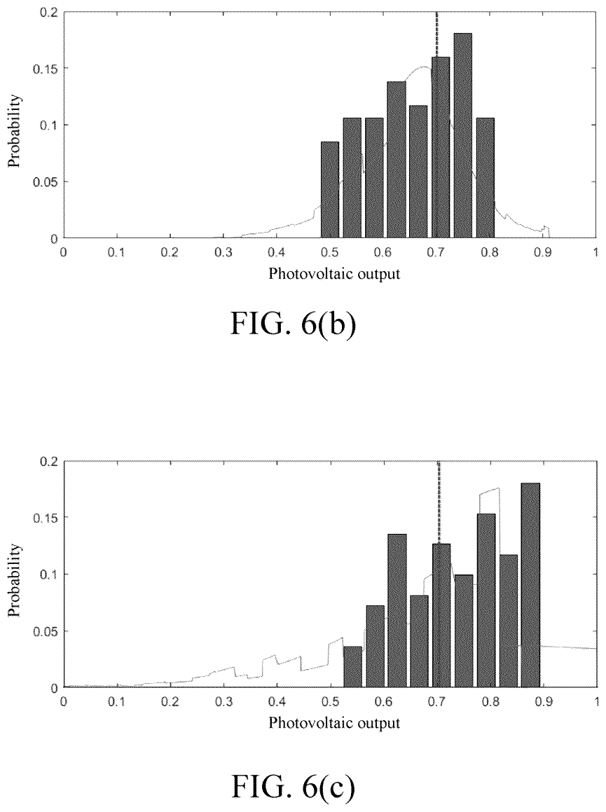

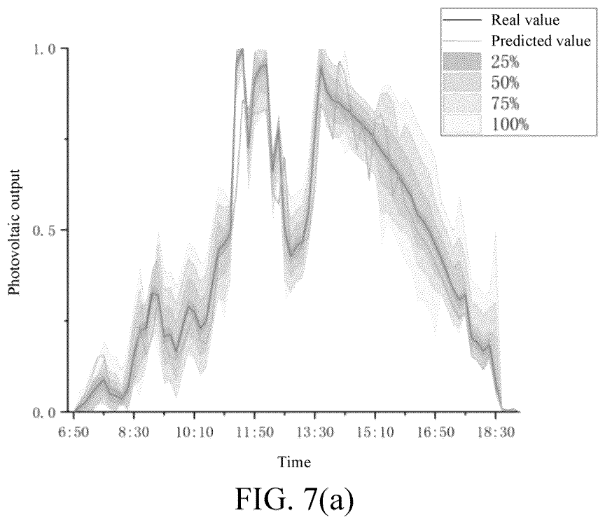

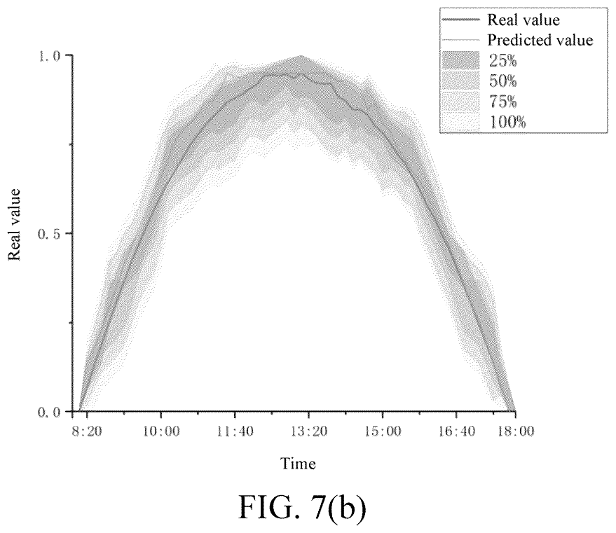

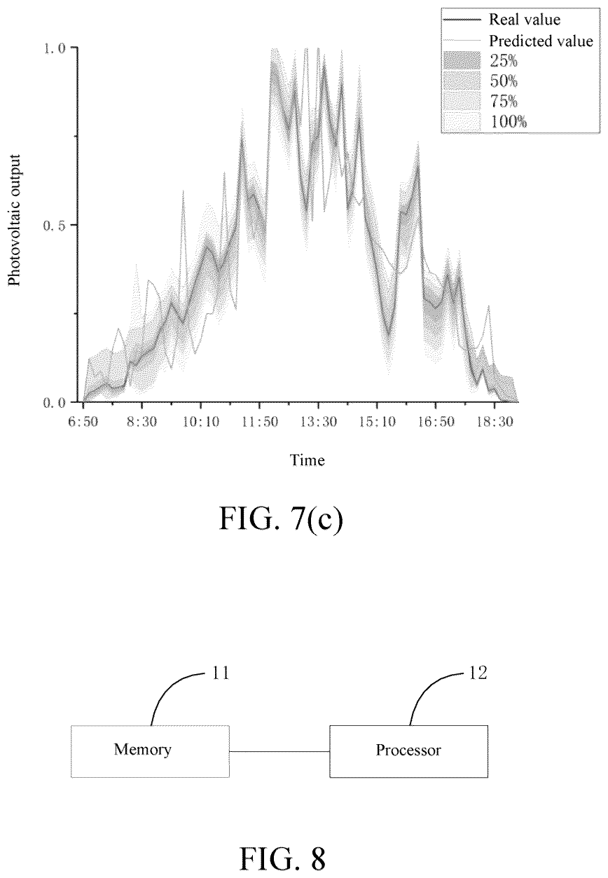

Equation (6) shows that the conditional probability density includes two parts: the density of the Copula function with variable multipliers and the density of the probability function of the actual value. The conditional probability distribution of the photovoltaic output under different weather types when the final point prediction is 0.7 is as shown in FIG. 6(a) to FIG. 6(c). From FIG. 6(a) to FIG. 6(c), it can be seen that the conditional probabilities of different weather types are different under the same point prediction, and thus the overall probability prediction diagram is established, as shown in FIG. 7(a) to FIG. 7(c). On this basis, based on the real value of the power of the centralized photovoltaic power station at the future moment and in combination with the above conditional probability model, the predicted value of the power generated by the distributed photovoltaic power station at the future moment is obtained.

To illustrate the practical effect of the probability estimation method for photovoltaic power provided by the embodiment of the present disclosure, the inventors conducted simulation experiments to evaluate and test the predicted conditional probabilities, the prediction results are as shown in FIG. 7(a) to FIG. 7(c), and the evaluation results are as shown in Table 3.

TABLE 3

| Predicting and | Average width of a | Average width of a |
|---|---|---|
| estimating | 50% prediction | 90% prediction |
| method | interval | interval |
| Frank Copula model | 0.18 | 0.35 |
| Hybrid Copula model | 0.16 | 0.32 |

As can be seen from FIG. 7(a) to FIG. 7(c), the probability estimation method for photovoltaic power provided by the embodiment of the present disclosure can carry out conditional probability prediction on all point predictions and can obtain prediction information on different confidence intervals. Table 3 demonstrates that the optimized hybrid Copula model outperforms the single Copula model in the probability prediction result using only the average width of the prediction intervals.

### EMBODIMENT II

On the basis of the above probability estimation method for photovoltaic power, Embodiment II of the present disclosure further provides a probability estimation apparatus for photovoltaic power. As shown in FIG. 8, the probability estimation apparatus for photovoltaic power includes one or more processors 11 and a memory 12. The memory 12 is coupled to the processor 11 for storing one or more programs, when the one or more programs are executed by the one or more processors 11, the one or more processors 11 are enabled to implement the probability estimation method for photovoltaic power as in the above embodiment.

The processor 11 is used for controlling the overall operation of the probability estimation apparatus for photovoltaic power to accomplish all or some of the steps of the above probability estimation method for photovoltaic power. The processor 11 may be a central processing unit (CPU), a graphics processing unit (GPU), a field programmable gate array (FPGA), an application specific integrated circuit (ASIC), a digital signal processing (DSP) chip, etc. The memory 12 is used for storing various types of data to support operation at the probability estimation apparatus for photovoltaic power, the data may include, for example, instructions for any application program or method to operate on the probability estimation apparatus for photovoltaic power, as well as application program-related data.

The memory 12 may be implemented by any type of volatile or non-volatile storage devices or combinations thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, etc.

In an exemplary embodiment, the probability estimation apparatus for photovoltaic power may be implemented specifically by a computer chip or entity, or by a product having some functionality for executing the above probability estimation method for photovoltaic power, and achieving the technical effects consistent with those achieved in the above method. An exemplary embodiment relates to a computer. Specifically, the computer may be, for example, a personal computer, a laptop computer, an in-vehicle human-computer interaction device, a cellular phone, a camera phone, a smart phone, a personal digital assistant, a media player, a navigation device, an E-mail device, a game control panel, a tablet personal computer, a wearable device, or a combination of any of these devices.

In another exemplary embodiment, the present disclosure further provides a computer-readable storage medium including program instructions, the program instructions, when executed by a processor, implementing the steps of the probability estimation method for photovoltaic power according to any one of the above embodiments. For example, the computer-readable storage medium may be a memory including program instructions, and the above program instructions may be executed by the processor of the probability estimation apparatus for photovoltaic power to accomplish the above probability estimation method for photovoltaic power and achieve the technical effects consistent with those achieved in the above method.

### EMBODIMENT III

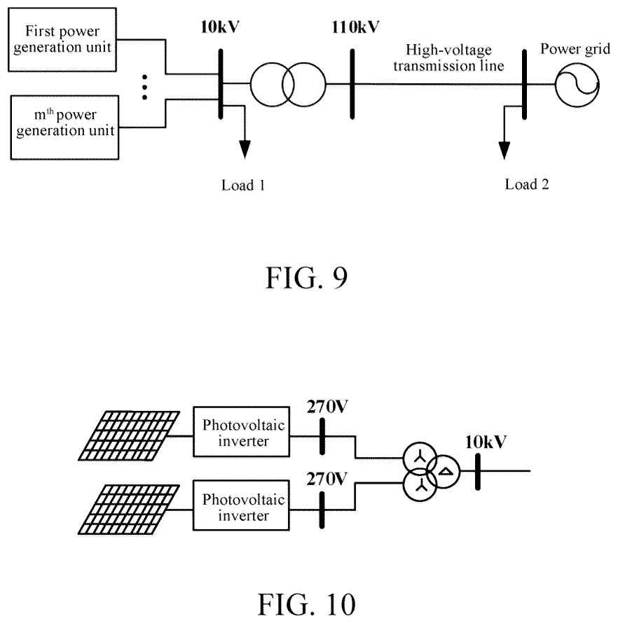

Embodiment III of the present disclosure provides a photovoltaic power system, using the above probability estimation method for photovoltaic power to estimate the photovoltaic power. As shown in FIG. 9, the photovoltaic power system includes m power generation units (m is a positive integer). FIG. 10 is a schematic structural diagram of each power generation unit. By rising the voltage to 270 V through a corresponding photovoltaic inverter and further rising the voltage to 10 kV through a transformer, a centralized photovoltaic power station or a distributed photovoltaic power station in each power generation unit is each connected to a power grid. After rising the voltage from 10 kV to 110 kV, the electric energy output from these power generation units is then connected to the power grid through high-voltage transmission lines. The above probability estimation apparatus for photovoltaic power can be installed in an operation and dispatch system of a power grid (not shown in the figure) for achieving photovoltaic power estimation using the probability estimation method for photovoltaic power, which provides a more accurate reference data for operation and dispatch of the power grid.

Compared with the prior art, the probability estimation method for photovoltaic power provided by the present disclosure creatively applies the combination of a clustering algorithm and the optimized copula model under weather classification to the field of predicting the power of the distributed photovoltaic power station, carries out weather clustering based on historical meteorological data, and constructs the copula function model based on the clustering results. Historical operation data and weather classification results are considered at the same time to make the obtained hybrid Copula function model have higher prediction accuracy. The probability estimation method for photovoltaic power predicts the power of the distributed photovoltaic power station through the centralized photovoltaic power station, solving the problem that operational data of the distributed photovoltaic power station is difficult to collect and providing strong support for the safe and stable operation of the photovoltaic power system.

The probability estimation method for photovoltaic power based on an optimized copula function and the photovoltaic power system provided by the present disclosure are described in detail below. To a person of ordinary skill in the art, any obvious changes made to the present disclosure without departing from the substance of the present disclosure will constitute an infringement of the patent rights of the present disclosure and will be subject to the corresponding legal liability.

What is claimed is:

1. A probability estimation method for photovoltaic power based on an optimized copula function, comprising the following steps:
(1) classifying, according to historical photovoltaic power data obtained from a centralized photovoltaic power station and a distributed photovoltaic power station, weather types by a clustering method to obtain a plurality of weather types;
(2) constructing, according to the cumulative distribution of the photovoltaic output obtained from photovoltaic data under different weather types, a plurality of copula function models for quantitatively representing the spatial correlation of the power of the centralized photovoltaic power station and the distributed photovoltaic power station, respectively;
(3) evaluating the plurality of copula function models respectively for different weather, and obtaining a copula function model achieving the highest accuracy for predicting the photovoltaic power under the corresponding different weather as an optimal model;
(4) achieving, according to the obtained data of the centralized photovoltaic power station, point prediction of the distributed photovoltaic power station, through the optimal model of the corresponding weather;
(5) constructing, based on the relationship between an actual value and a value of point prediction of the distributed photovoltaic power station, a conditional probability model and obtaining, through the conditional probability model, the probability distribution of the power of the distributed photovoltaic power station and the conditional probability corresponding to the value of point prediction; and
(6) obtaining, based on a real value of the power of the centralized photovoltaic power station at the future moment and in combination with the above conditional probability model, a predicted value of the power generated by the distributed photovoltaic power station at the future moment.

2. The probability estimation method for photovoltaic power according to claim 1, wherein step (1) comprises the following sub-steps:
obtaining historical photovoltaic power data and performing data cleaning; and
obtaining meteorological data in the corresponding period of the historical photovoltaic power data, and determining, based on correlation analysis, clustering elements to cluster the weather to obtain the plurality of weather types.

3. The probability estimation method for photovoltaic power according to claim 2, wherein
the correlation analysis is used for determining meteorological factors affecting the photovoltaic output as the clustering elements; and
according to the determined clustering elements, the weather is clustered using a k-means algorithm.

4. The probability estimation method for photovoltaic power according to claim 3, wherein
the meteorological factors comprise an atmospheric pressure, relative humidity and radiancy.

5. The probability estimation method for photovoltaic power according to claim 1, wherein in step (2), the plurality of copula function models comprise a Frank Copula function model and a hybrid Copula function model, the hybrid Copula function model being a weighted sum of the Frank Copula function model and other models in an Archimedean Copula function cluster model.

6. The probability estimation method for photovoltaic power according to claim 5, wherein the hybrid Copula function model is obtained through the following sub-steps:
obtaining, according to the cumulative distribution of the photovoltaic output, a correlation coefficient value under each weather type, and establishing the Frank Copula function model; and
constructing, based on other functions in an Archimedean Copula function cluster other than a Frank Copula function, a Copula function cluster model corresponding to each weather, and weighting and summing the Copula function cluster model and the Frank Copula function model according to weights to obtain an optimized hybrid Copula function model.

7. The probability estimation method for photovoltaic power according to claim 1, wherein in step (3), an optimal Copula model corresponding to each weather type is selected from a Frank Copula model and an optimized hybrid Copula function model by comparing correlation coefficients and an error evaluation index under different weather.

8. The probability estimation method for photovoltaic power according to claim 7, wherein
the correlation coefficients comprise: a Pearson correlation coefficient and a determination coefficient R2, and the error evaluation index is a root mean square error.

9. A probability estimation apparatus for photovoltaic power based on an optimized copula function, comprising a processor and a memory, the processor reading a computer program in the memory for executing the probability estimation method for photovoltaic power based on an optimized copula function according to claim 1.

10. A photovoltaic power system, comprising a plurality of power generation units; a centralized photovoltaic power station or a distributed photovoltaic power station in each power generation unit being each connected to a power grid through a corresponding photovoltaic inverter and transformer, wherein the probability estimation method for photovoltaic power based on an optimized copula function according to claim 1 is used for estimating the photovoltaic power.
